(19) United States
(12) Patent Application Publication
(10) Pub. No.: US 2014/0007490 A1
(43) Pub. Date: Jan. 9, 2014

(54) INSECTICIDAL CARTRIDGE

(71) Applicant: Gleb Vladimirovitch LOKSHIN, Moscow (RU)

(72) Inventor: Gleb Vladimirovitch LOKSHIN, Moscow (RU)

(21) Appl. No.: 13/932,136

(22) Filed: Jul. 1, 2013

(30) Foreign Application Priority Data
Jul. 4, 2012 (UA) A201208192

(51) Int. Cl. A01M 1/20

(52) U.S. Cl. CPC A01M 1/2066
USPC 43/127

(57) ABSTRACT

An efficient, safe, and inexpensive insecticidal cartridge is proposed, including a body, an upper diaphragm having a priming through hole, upper and lower paper diaphragms, a lower diaphragm, a smoke-forming agent disposed within the body, and an active substance providing insecticidal and/or acaricidal action, disposed within the body, interacting with the smoke-forming agent during burning or smoldering thereof. The lower diaphragm may have a number of gas-passing through holes overlaid with the lower paper diaphragm. The active substance may be dispersed within the smoke-forming agent, or may be separated therefrom by a separation diaphragm. Microcapsules and/or porous particles and/or pellets, encapsulating or being impregnated with the active substance, can be used. They can be distributed over the smoke-forming agent, or placed in a separate compartment arranged within the body being connected with the smoke-forming agent. A fume-passing channel and a filtering and gas-passing element can be mounted within the body.

### CROSS-REFERENCE TO RELATED APPLICATION

This U.S. patent application claims priority under 35 U.S.C. 119 (a) through (d) from a Ukraine's patent application UA a2012 08192 filed on 4 Jul. 2012 hereby entirely incorporated by reference.

### FIELD OF THE INVENTION

The invention relates to means for disinfection and/or disinsection, particularly to smoke-forming articles, which may be used in agriculture, livestock farming, veterinary practice, medicine, municipal service, transportation industry, as well as during elimination of nidi of infectional and entomological contamination.

### BACKGROUND OF THE INVENTION

The most efficient and cost-effective way of disinfection and disinsection especially for treating large areas, facilities having inner cavities or surfaces of microporous structure (like concrete, wood or plaster), for treating animals and so on, is using aerosols, i.e. disperse systems, comprised of fine particles suspended in a gaseous medium. Using aerosols provides penetration of the suspended particles into hard-to-reach places.

As means implementing a method of volumetric disinfection, pyrotechnical cartridges are used. Operation of such cartridges is bound to using smoke-forming pyrotechnical mixtures. Such mixtures envisage containing an active substance and a thermal composition providing burning (or smoldering) process and sublimation of the active substance.

Conventionally, components of such mixtures are ammonium chloride, aromatic hydrocarbons (like naphthalene, anthracene phenanthrene, etc.), and some fatty hydrocarbons. The active substances are highly toxic chlorine-containing compounds like hexachloran, hexachlorocyclohexane gamma isomer, dichlorodiphenyltrichloroethane (i.e. second generation insecticides).

These substances have cumulative effect and they are highly toxic for hematothermals; during operation they are dangerous for respiratory organs and for mucous membranes. Thus, any pyrotechnical means containing compounds of above mentioned substances is prohibited.

In order to reduce toxicity of insecticidal means, pyrethroids were proposed to be used as the active substance.

Pyrethroids are characterized by a high insecticidal action and non-toxicity for hematothermals, they rapidly decompose in the light, in water and in the soil, thus avoiding environmental pollution.

Smoke-forming cartridge manufacturing technologies are known from the related art, which technologies implement mixing wet or dry components, forming an article by compression, thermo-compression, extrusion or the like and, if needed, drying, impregnation with components or applying a protective coating. The mixture may be placed into a casing made of incombustible or combustible material.

An insecticidal pyrotechnical cartridge compressed into a cylinder is known from product specification 9392-006-12531300-98 of year 1998 (Russia's TY 9392-006-12531300-98, 1998).

By mixing components of the cartridge a uniform mass is obtained, which mass is well compressible and keeps its shape. The article is provided without any enclosure or casing, and that often causes breakage during storage and transportation. When using the cartridge, it is necessary to employ an incombustible substrate.

An insecticidal smoke cartridge is known from product specification 9392-025-47533666-2009 of year 2009 (TY 9392-025-47533666-2009, 2009), which cartridge is formed as a metal (tin) can hermetically sealed filled up with a powder containing permethrin (5%), an oxidant, a flash extinguisher and a filling material (i.e. talc).

When using this means, it is necessary to move human beings, animals, birds and plants out of the premises to be treated. Another drawback is the active substance being immediately close to the composition components. The oxidant decomposes at the burning temperature of 400° C., thus evolving oxygen and partly destructing the structure of the active substance. Due to this, the amount of the substance necessary for treatment and the duration of treatment are increased.

### OBJECT AND BRIEF DESCRIPTION OF THE INVENTION

The invention is primary aimed at providing efficient and safe pyrotechnical insecticidal smoke means, as well as at diversification of disinfection and/or insecticidal means.

This object is achieved by the claimed invention, which provides for an advantageous effect that allows improving operation safety, assures integrity during storage and transportation of insecticidal smoke means, as well as enhances efficiency and operational reliability of such means. The advantageous effect is attained by a simple engineering design of an inventive insecticidal cartridge that can be easily manufactured.

The inventive cartridge generally comprises a body filled up with a pyrotechnical agent and an active substance, i.e. an insecticidal and acaricidal component.

The inventive cartridge generally comprises an upper diaphragm having a priming through hole for inputting the smoke-forming agent and the active substance into the body and a lower diaphragm having at least one gas-passing through hole, or having no holes; the upper diaphragm and lower diaphragm are located at butt ends of the body; wherein the cartridge further comprises an upper paper diaphragm, and a lower paper diaphragm; the lower diaphragm has a number of holes, the paper diaphragms overlap corresponding gas-passing holes from the inside.

In some inventive embodiments, there are no gas-passing through holes in the lower diaphragm, therefore the lower paper diaphragm is not used.

In another inventive embodiment of the cartridge, the lower diaphragm may also have a priming hole.

In another inventive embodiment, the cartridge comprises a composition, wherein the active substance is dispersed in the mass of organic smoke-forming agent of the pyrotechnical composition.

In another inventive embodiment, the cartridge comprises microcapsules and/or porous particles and/or hygroscopic pellets containing the active substance and being distributed over the pyrotechnical composition or separated from the pyrotechnical composition by a separation diaphragm having at least one hole.

In another version the cartridge comprises a filtering and gas-passing element made of porous and/or hygroscopic material, the element is impregnated with the active substance. Some riffles may be provided in the element; the riffles facilitate outflow of the gaseous products.

As the active substance (i.e. insecticidal and acaricidal component), pyrethroid compositions may be used, including permethrin, cypermethrin, α-cypermethrin, chlorpyriphos, etoc (2,2-dimethyl-3-(2-methyl-1-propenyl)cyclopropanecarboxylic acid 2-methyl-4-oxo-3-(2-propynyl)cyclopenten-1-yl ester) and other compounds meeting safety requirements and having properties required for using thereof in the cartridge of the proposed engineering design.

As the smoke-forming agent, a composition may be used, containing potassium chlorate, ammonium chloride, organic smoke-forming agent i.e. hydrocarbon fuel (wax, colophony, paraffin and the like), and chalk.

### BRIEF DESCRIPTION OF DRAWINGS OF THE INVENTION

FIG. 1 is a sectional view of the insecticidal cartridge according to an embodiment of the present invention.

FIG. 2 is a sectional view of the insecticidal cartridge according to another embodiment of the present invention.

FIG. 3 is a sectional view of the insecticidal cartridge according to another embodiment of the present invention.

FIG. 4 is a sectional view of the insecticidal cartridge according to another embodiment of the present invention.

### EXEMPLARY EMBODIMENTS OF THE INVENTION

While the invention may be susceptible to embodiment in different forms, there are described in detail herein below, specific embodiments of the present invention, with the understanding that the instant disclosure is to be considered an exemplification of the principles of the invention, and is not intended to limit the invention to that as described herein.

The above examples of the compounds used are preferable but not limiting the claimed engineering solution.

The cartridge body is made of combustible or incombustible material.

Firing in all the claimed cartridge embodiments is implemented via the priming hole constituting the priming portion, e.g. by means of a splinter, a wind-proof match, a hunting match, or a strand of quick match (fuse). Frictional firing or electrical firing is also possible. The upper diaphragm inhibits fast outflow of the gaseous products from the pyrotechnical composition surface. The hot by-products of burning (or smoldering) the pyrotechnical composition are accumulated over the surface, thus forming corresponding thermal front and additional pressure and providing uniform heat distribution over the entire working surface and uniform layered heat penetration.

As a result, contrary to related art teachings, in the claimed cartridge embodiments, combustion is steady and smooth. The active substance is distributed over the mass of the organic smoke-forming agent by mixing the active substance solution and the smoke-forming agent solution with appropriate solvents. For the above mentioned substances the solvent may be acetone or alcohol.

The distribution of the active substance over the mass of the organic smoke-forming agent of the pyrotechnical composition is provided by mixing the active substance solution and the smoke-forming agent solution with appropriate solvents, then mixing the resulting solution with other components of the compound e.g. microspheres, and heating the resulting mass until total removal of the solvent. Acetone or alcohol may be used as the solvent.

Thus, the organic smoke-forming agent forms a continuum (a matrix) over which the other components are distributed. The insecticide is dispersed/emulsified in the mass of the smoke-forming agent. Such allocation of insecticide isolates the insecticide from direct exposure to a high temperature during action of an oxidant, therefore, this protects the insecticide from partial thermal disintegration. The matrix formed facilitates uniform warming the entire mass of the composition. Combustion of the mixture obtained in such a way, is smooth and is characterized by steady layered smoldering.

An embodiment of the inventive cartridge envisages microcapsuling the active substance or impregnating porous particles (pellets) with the active substance, wherein microcapsuling is done using a known technology, and the porous particles (pellets) are impregnated with the active substance in advance. By distribution of the microcapsules or the impregnated particles over the pyrotechnical composition, isolation of the active substance from direct disintegrating conditions is assured. In the porous particles, silica gel or carbon or the like may be used.

An embodiment of the inventive cartridge provides the most sparing way of the active substance sublimation. Particularly, this is the engineering design that provides separation of the microcapsules and/or porous particles or pellets containing the active substance from the pyrotechnical composition by means of a separation diaphragm having a hole. Uniform warming the particles and the active substance sublimation are provided by directing hot gaseous products of the pyrotechnical composition smoldering via at least one hole in the separation diaphragm.

The filtering and gas-passing element may be made of combustible or incombustible porous and/or hygroscopic material. The element is impregnated with the active substance beforehand and is uniformly warmed during the burning (smoldering) of pyrotechnical composition, thus providing sublimation of the active substance.

The gas-passing element may be mounted between the body of the cartridge and the pyrotechnical composition. Riffles provided to the whole face of the element from the side facing the body, facilitate passing off the sublimation products. The active substance to be sublimated is still isolated from the pyrotechnical composition, which assures mild conditions for generating the active products.

Thus, the claimed invention is free from the aforementioned drawbacks of the known insecticidal means and allows for attaining new advantageous effects regarding aerosol treatment such as low consumption of the active substance, providing particles having high penetration capability, convenient use, having no need of labor-intensive removal of residual disinfectant/disinsectant from the treated surface etc. The claimed device provides diversification of disinfection and disinsection means and effective use thereof.

The inventive cartridge can exemplarily be manufactured in the following way.

The body in the form of a cylinder is rolled from a predeterminedly dense paper, cardboard, or the like. One of the diaphragms (lower or upper) is mounted at a butt end of the body thereby forming a cavity. The cavity formed is filled up with a composition of the active substance dispersions or a composition containing microcapsules and/or porous particles and/or pellets containing the active substance. The cartridge may be filled up with the pyrotechnical composition in the form of solution or wet mass, the solvent of which is to be removed afterwards. Filling up with a beforehand obtained mass in the forms of powder or compacted solid, with a possible further compression thereof. Then the other diaphragm (upper or lower respectively) is mounted. A priming through-hole and gas-passing through-holes can be provided in the diaphragm and overlaid with a paper diaphragm from the inside in order to protect the composition from the environment and to assure its damp-proof during continuous storage.

When manufacturing another embodiment of the cartridge, the cavity formed is filled with the pyrotechnical composition partially. A separation diaphragm is placed on the open surface of the composition; microcapsules and/or porous particles and/or pellets containing the active substance are put on the separation diaphragm; and the butt end is covered with the lower diaphragm. Thus, the volume of the cartridge is divided into two compartments; one of them containing the smoke-forming composition in which one or more gas-passing channels of arbitrary configuration are provided, the channels connect the two compartments of the cartridge; and the other one contain capsules or pellets including the active substance. The gas-passing channel provides passing hot gas into the other compartment of the cartridge, thus providing warming up and sublimating the active substance.

In another embodiment of the inventive cartridge, a filtering and gas-passing element impregnated with the active substance is placed after mounting one of the diaphragms (the upper or the lower) in the body. Then the body is filled up with the composition and the butt end is covered with the other diaphragm (the lower or the upper respectively). However this position of the filtering and gas-passing element is not limiting and relates just to one of possible combinations.

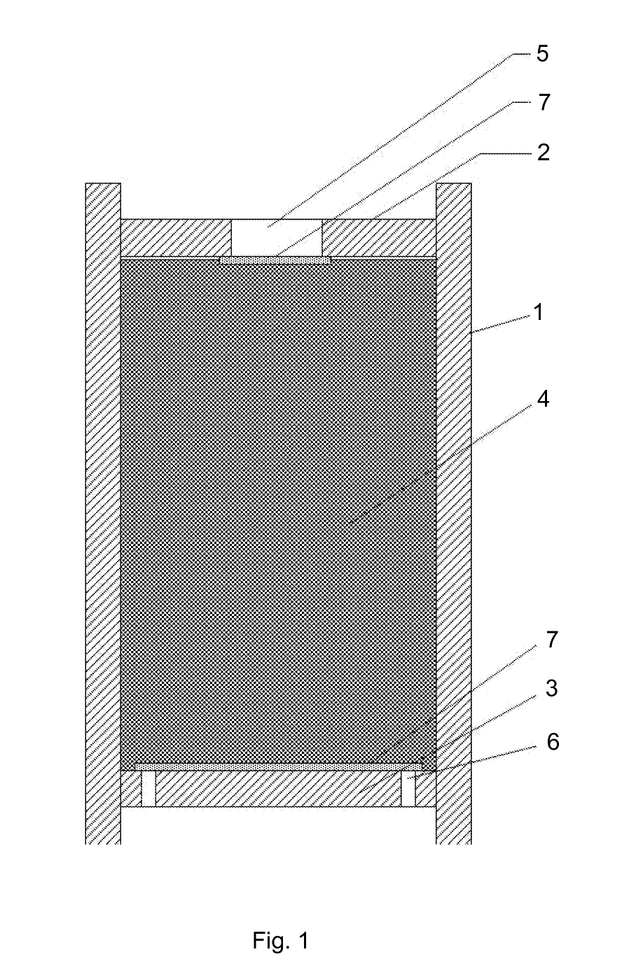

The engineering design of the claimed articles is illustrated by FIGS. 1-4.

FIG. 1 shows an insecticidal cartridge comprising a body 1 made as a cardboard tube, an upper diaphragm 2, a lower diaphragm 3, a smoke-forming pyrotechnical agent 4 containing an active substance, a priming through-hole 5, gas-passing through-holes 6, and paper diaphragms 7.

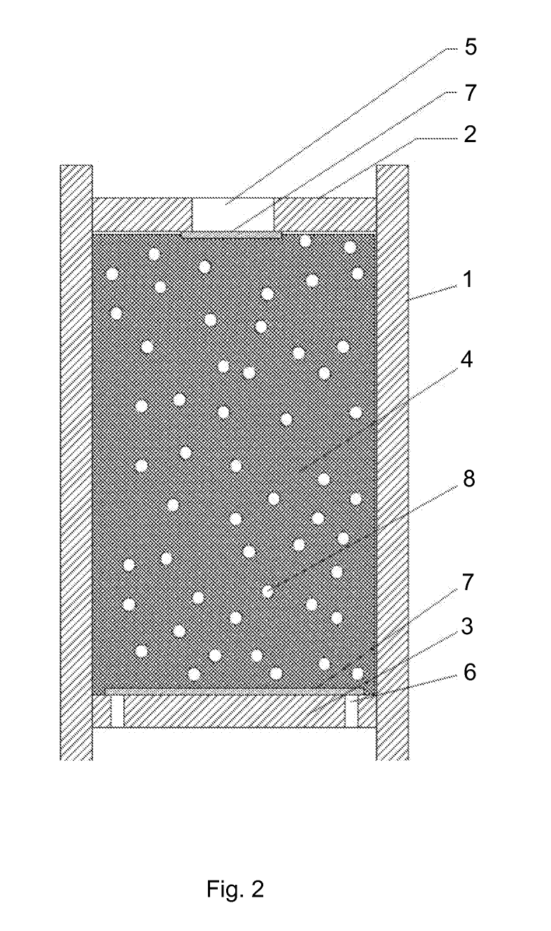

FIG. 2 shows an insecticidal cartridge comprising a body 1 made as a cardboard tube, an upper diaphragm 2, a lower diaphragm 3, a smoke-forming pyrotechnical agent 4, a priming through-hole 5, gas-passing through-holes 6, paper diaphragms 7, and microcapsules and/or porous particles and/or pellets 8 containing an active substance uniformly spread throughout the mass of agent 4.

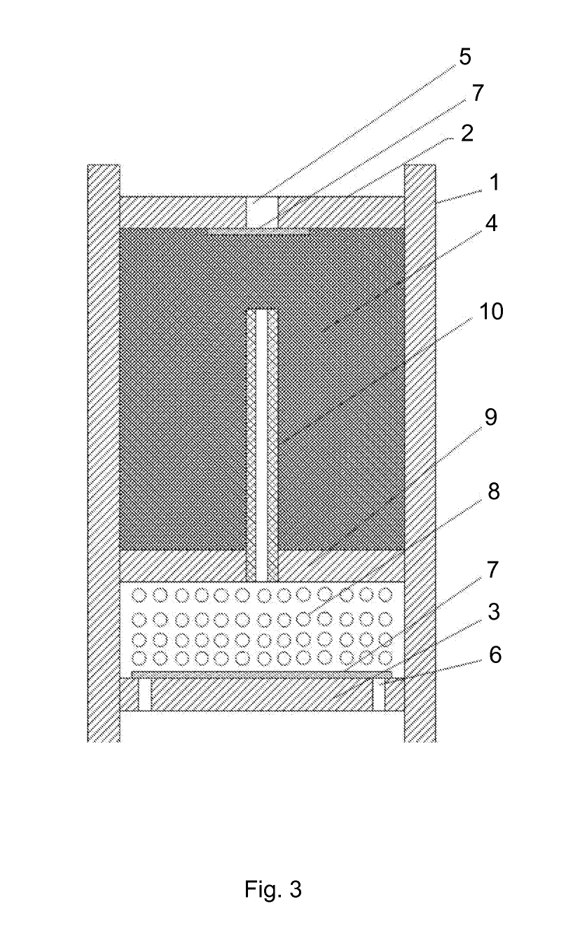

FIG. 3 shows an insecticidal cartridge comprising a body 1 made as a cardboard tube having an interior; an upper diaphragm 2; a lower diaphragm 3; a separation diaphragm 9 dividing the interior into two compartments: an upper compartment and a lower compartment; a fume-passing channel 10 mounted in the upper compartment and extending through the separation diaphragm 9 thus communicating the upper compartment with the lower compartment; a smoke-forming pyrotechnical agent 4 placed in the upper compartment; a priming through-hole 5; a number of gas-passing through-holes 6 essentially communicating the lower compartment with the surrounding environment; an upper paper diaphragm 7 overlaying the priming through-hole 5, and a lower paper diaphragm 7 overlaying the gas-passing through-holes 6; microcapsules and/or porous particles and/or pellets 8 containing an active substance and placed into the lower compartment.

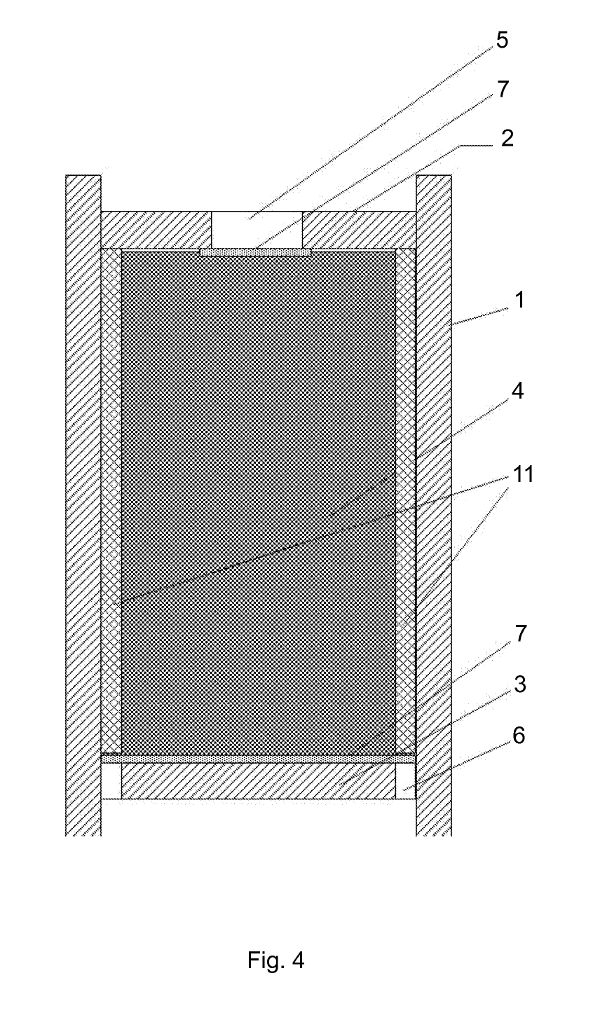

FIG. 4 shows an insecticidal cartridge comprising a body 1 made as a cardboard tube having inner sidewalls; an upper diaphragm 2; a lower diaphragm 3; a priming through-hole 5; gas-passing through-holes 6; upper and lower paper diaphragms 7 overlaying the priming through-hole 5 and the gas-passing through-holes 6 respectively; a filtering and gas-passing element 11 shaped as a tube and disposed adjacent to the inner sidewalls of the body; and a smoke-forming pyrotechnical agent 4 filling the interior of the body 1.

The use of the inventive insecticidal articles for disinfection and/or disinsection contemplates burning the pyrotechnical composition within a confined volume (for example, a room), in which an object (e.g. an animal, or an item) to be treated is placed, or burning the pyrotechnical composition in the open air so as the object to be treated is placed within the fume jet which is easily visible.

The cartridge produces dense white smoke having almost no smell, the smoke being non-toxic and anallergic. The fuming starts a few seconds after firing and forms a dense fume curtain. When using in the open air, the amount of the composition to be burnt is determined based on certain relationships considering the distance to the object, meteorological conditions and so on, so as to assure aerosol exposition to be enough for providing required effect. Smolder of the pyrotechnical mixture provides sublimation of the active substance, thus providing lower consumption of the means.

The claimed cartridge is irreplaceable when removing human beings or animals out of the means coverage is not possible.

The use of the invention provides continuous protective effect in regard to subsequent contamination.

I claim:

1. An insecticidal cartridge comprising:
a body including sidewalls, an upper opening, a lower opening, and a hollow interior;
an upper diaphragm mounted to the sidewalls, covering said upper opening; said upper diaphragm having a first priming through hole;
an upper paper diaphragm disposed under said upper diaphragm, and overlaying said priming through-hole;
a lower diaphragm mounted to the sidewalls, covering said lower opening;
a smoke-forming agent disposed within said hollow interior; and
an active substance providing insecticidal and/or acaricidal action, disposed within said hollow interior;
wherein said active substance is capable of interaction with said smoke-forming agent during burning or smoldering thereof.

2. The insecticidal cartridge according to claim 1,
wherein said lower diaphragm having a number of gas-passing through holes; and
said cartridge further comprising a lower paper diaphragm disposed over said lower diaphragm and overlaying said number of gas-passing through holes.

3. The insecticidal cartridge according to claim 2, further comprising a second priming through hole, and the lower paper diaphragm overlays said second priming through hole.

4. The insecticidal cartridge according to claim 2, wherein said smoke-forming agent is an organic smoke-forming agent is characterized with a mass, and the active substance is dispersed in the mass of said organic smoke-forming agent.

5. The insecticidal cartridge according to claim 1, wherein
the body is made of combustible or incombustible material; and
the active substance is represented by one of the following: permethrin, cypermethrin, α-cypermethrin, chlorpyriphos, or etoc.

6. The insecticidal cartridge according to claim 2, wherein
the body is made of combustible or incombustible material; and
the active substance is represented by one of the following: permethrin, cypermethrin, α-cypermethrin, chlorpyriphos, or etoc.

7. The insecticidal cartridge according to claim 2, further comprising:
microcapsules and/or porous particles and/or pellets encapsulating the active substance or being impregnated with the active substance; and said microcapsules and/or porous particles and/or pellets are distributed over said smoke-forming agent.

8. The insecticidal cartridge according to claim 7, wherein:
the active substance is represented by one of the following: permethrin, cypermethrin, α-cypermethrin, chlorpyriphos, or etoc; and
the microcapsules and/or porous particles and/or pellets contain silica gel or carbon.

9. The insecticidal cartridge according to claim 2, further comprising:
a separation diaphragm having at least one hole, said separation diaphragm divides the hollow interior into a first compartment and a second compartment, wherein said smoke-forming agent is placed into the first compartment; and
microcapsules and/or porous particles and/or pellets encapsulating the active substance or being impregnated with the active substance, and said microcapsules and/or porous particles and/or pellets are placed into the second compartment.

10. The insecticidal cartridge according to claim 9, wherein:
the active substance is represented by one of the following: permethrin, cypermethrin, α-cypermethrin, chlorpyriphos, or etoc; and
the microcapsules and/or porous particles and/or pellets contain silica gel or carbon.

11. The insecticidal cartridge according to claim 9, further comprising: at least one fume-passing channel mounted in the upper compartment and extending through the separation diaphragm thus communicating the upper compartment with the lower compartment.

12. The insecticidal cartridge according to claim 2, further comprising: a filtering and gas-passing element disposed adjacent to said sidewalls.

13. The insecticidal cartridge according to claim 12, wherein said gas-passing element is impregnated with the active substance.

14. The insecticidal cartridge according to claim 12, wherein said gas-passing element is made of porous and/or hygroscopic material being combustible or in combustible.

15. The insecticidal cartridge according to claim 9, further comprising: a filtering and gas-passing element disposed adjacent to said sidewalls.

16. The insecticidal cartridge according to claim 15, wherein said gas-passing element is impregnated with the active substance.

17. The insecticidal cartridge according to claim 15, wherein said gas-passing element is made of porous and/or hygroscopic material being combustible or in combustible.
